(19) United States
(12) Patent Application Publication
(10) Pub. No.: US 2017/0274758 A1
(43) Pub. Date: Sep. 28, 2017

(54) RESERVOIR TANK OF HYBID VEHICLE

(71) Applicants: Hyundai Motor Company, Seoul (KR); Kia Motors Corporation, Seoul (KR)

(72) Inventors: Wan Je Cho, Hwaseong (KR); Yeon Ho Kim, Seoul (KR); Jae Yeon Kim, Hwaseong (KR)

(21) Appl. No.: 15/268,723

(22) Filed: Sep. 19, 2016

(30) Foreign Application Priority Data
Mar. 28, 2016 (KR) 10-2016-0037190

(51) Int. Cl. B60K 11/02; B60K 6/22; B65D 25/04

(52) U.S. Cl. CPC B60K 11/02; B65D 25/04; B60K 6/22; Y10S 903/904; B60Y 2200/92; B60Y 2400/43

(57) ABSTRACT

A reservoir tank for a vehicle includes an upper body provided with an inflow pipe and a lower body provided with a discharge pipe, the upper and lower bodies being assembled to each other. An inside of the upper body and the lower body is installed on a coolant passage while being partitioned into a plurality of chambers, where one side of an upper portion of the upper body is provided with the inflow pipe parallel therewith, and the upper body is integrally connected to a guide pipe in a vertical direction to the inflow pipe to downwardly guide coolant. The lower body is provided with a guide rib corresponding to the guide pipe to enclose an outer side of a tip portion of the guide pipe while the guide rib is spaced apart from the outer side of the tip portion of the guide pipe at a predetermined interval to form the coolant passage between the guide rib and the guide pipe.

### CROSS-REFERENCE TO RELATED APPLICATION

This application claims under 35 U.S.C. §119(a) the benefit of Korean Patent Application No. 10-20166-0037190 filed in the Korean Intellectual Property Office on Mar. 28, 2016, the entire contents of which are incorporated herein by reference.

### BACKGROUND

(a) Technical Field

The present invention relates to a reservoir tank, and more particularly, to a reservoir tank connected to a coolant passage of a hybrid vehicle in series that can minimize a water passage resistance and increase an actual vehicle flux.

(b) Description of the Related Art

Generally, while a vehicle is being driven, an explosion temperature within an engine combustion chamber reaches approximately 1500° C.

If the temperature within the combustion chamber is not appropriately cooled, an engine overheats, and therefore the engine and various parts may be damaged, lubricant viscosity may be reduced, abnormal combustion may occur, or the like, such that the engine may be in an inoperable state.

Therefore, the engine includes an engine cooling apparatus for cooling, in which the engine cooling apparatus supplies coolant from a cylinder block and a cylinder head to a coolant chamber to lower the temperature around the combustion chamber and maintain the lower temperature around the combustion chamber to thereby stably operate a piston, various valve mechanisms, or the like.

The engine cooling apparatus is divided into an air cooling type that allows outside air to directly contact the engine to cool the high temperature engine and a water cooling type that circulates coolant to a surrounding area of the engine combustion chamber to cool the high temperature engine. Here, the air cooling type has cooling performance lower than the water cooling type. Therefore, vehicles typically utilize the water cooling type, which has the better cooling effect.

The water cooling type engine cooling apparatus typically includes a radiator cooling the high temperature coolant within the engine, a cooling fan sucking air through the radiator to assist a ventilation of the radiator, a water pump again supplying the coolant cooled in the radiator to a coolant passage of the engine, and a reservoir tank disposed in the coolant passage.

In this configuration, the reservoir tank may continuously store a predetermined amount of coolant and discharge bubbles generated from the coolant passing through the radiator and an engine system and supply the predetermined amount of coolant to the water pump to prevent the bubbles or a negative pressure from occurring in the coolant passage.

Unlike a general gasoline or diesel vehicle, in particular, the reservoir tank in a hybrid vehicle is connected to other parts of the coolant passage in series.

Further, the reservoir tank has a general structure in which an inflow pipe is disposed at a top end portion and a discharge pipe is disposed at a bottom end portion to finally discharge the bubbles within the coolant.

FIG. 1 (RELATED ART) is a cross-sectional view of a reservoir tank according to the related art.

Referring to FIG. 1, a reservoir tank 100 according to the related art includes an upper body 110 and a lower body 120, in which a plurality of partition walls 130 disposed at the upper body 110 and the lower body 120, respectively, are assembled to contact each other, thereby forming a separated chamber and coolant passage.

The reservoir tank 100 has a structure in which a passage is changed to make coolant inflowing from the inflow pipe 111 flow downwardly by adjacent partition walls 130.

In this case, the coolant collides with the partition walls 130 as soon as it inflows from the inflow pipe 111 to have a reduced flow velocity while being scattered.

Further, the passage of the coolant is suddenly changed by the partition walls 130 in the reservoir tank 100 to increase the water passage resistance, and therefore a problem may occur in which an actual vehicle flux is reduced.

The above information disclosed in this Background section is only for enhancement of understanding of the background of the invention and therefore it may contain information that does not form the prior art that is already known in this country to a person of ordinary skill in the art.

### SUMMARY

The present invention provides a reservoir tank in which one side of an upper portion of an upper body is integrally provided with a guide pipe in a vertical direction to an inflow pipe formed in parallel with the upper body, and an inner surface of a bent outer side of a connection part between the inflow pipe and the guide pipe is formed in a rounded curved surface to prevent coolant from being scattered and reduce a water passage resistance.

An exemplary embodiment of the present invention provides a reservoir tank in which an upper body provided with an inflow pipe and a lower body provided with a discharge pipe are assembled to each other, and an inside of the upper body and the lower body is installed on a coolant passage while being partitioned into a plurality of chambers, in which one side of an upper portion of the upper body may be provided with the inflow pipe parallel therewith and the upper body may be integrally connected to a guide pipe in a vertical direction to the inflow pipe to downwardly guide coolant and the lower body may be provided with a guide rib corresponding to the guide pipe to enclose an outer side of a tip portion of the guide pipe while the guide rib may be spaced apart from the outer side of the tip portion of the guide pipe at a predetermined interval to form a coolant passage between the guide rib and the guide pipe.

A coolant flow cross sectional area of the guide pipe may be formed to be larger than that of the inflow pipe.

The coolant flow cross sectional area of the guide pipe may be set to be two times or larger than that of the inflow pipe.

An inner surface of a bent outer side of a connection part between the inflow pipe and the guide pipe may be formed in a rounded curved surface.

The guide pipe may be connected to a side surface and an inner surface of the upper body by at least two reinforcing ribs.

The guide rib may be formed by connecting between one side surface and another side surface of a corner of one side of the lower body corresponding to the guide pipe.

An inlet of the discharge pipe may be positioned at a central portion of the lower body.

An outlet of the discharge pipe may be positioned at an outer side of the lower body by penetrating through the central portion of the lower body.

The upper body may have partition walls for partitioning a plurality of chambers and the respective partition walls of the upper body may be provided with a plurality of air bleeding holes.

The lower body may have partition walls for partitioning a plurality of chambers and central portions of the respective partition walls of the lower body may be provided with flow guiders guiding a flow of coolant between the respective chambers.

The flow guider may have a curved rectangular plate shape bent in a diagonal direction and both corners bent in a diagonal direction may each be formed on the respective partition walls of the lower body to direct to both chambers.

The respective partition walls of the upper body may be provided with flow grooves corresponding to the flow guiders to make coolant flow between the respective chambers, along with the flow guiders.

According to an embodiment of the present invention, in the state in which the upper body and the lower body are assembled to each other, one side of the upper portion of the upper body is provided with the inflow pipe in parallel with the upper body, the upper body is integrally provided with the guide pipe in a vertical direction to the inflow pipe, and the inner surface of the bent outer side of a connection part between the inflow pipe and the guide pipe is formed in the rounded curved surface, such that the flow of coolant may be smoothly guided to reduce the water passage resistance and minimize the reduction in the actual vehicle flux, thereby improving the cooling performance.

Further, according to an embodiment of the present invention, the coolant flow cross sectional area of the guide pipe may be formed to be larger than that of the inflow pipe, thereby preventing the coolant from being scattered to the extent possible.

Further, according to an embodiment of the present invention, the lower body may be provided with the guide rib to form the coolant passage between the guide rib and the guide pipe, such that the flow of coolant inflowing from the guide pipe may be naturally guided upwardly.

According to an embodiment of the present invention, a reservoir tank for a vehicle can include: an upper body provided with an inflow pipe; a lower body provided with a discharge pipe, the upper and lower bodies being assembled to each other; an inside of the upper body and the lower body installed on a coolant passage while being partitioned into a plurality of chambers; one side of an upper portion of the upper body provided with the inflow pipe parallel therewith, wherein the upper body is integrally connected to a guide pipe in a vertical direction to the inflow pipe to downwardly guide coolant; and the lower body is provided with a guide rib corresponding to the guide pipe to enclose an outer side of a tip portion of the guide pipe while the guide rib is spaced apart from the outer side of the tip portion of the guide pipe at a predetermined interval to form the coolant passage between the guide rib and the guide pipe.

Further, the effects which may be obtained or predicted by the exemplary embodiment of the present invention will be explicitly or implicitly disclosed in the detailed description of the exemplary embodiments of the present invention. That is, various effects which are predicted by the exemplary embodiments of the present invention will be disclosed in the detailed description to be described below.

### BRIEF DESCRIPTION OF THE DRAWINGS

FIG. 1 (RELATED ART) is a cross-sectional view of a reservoir tank according to the related art.

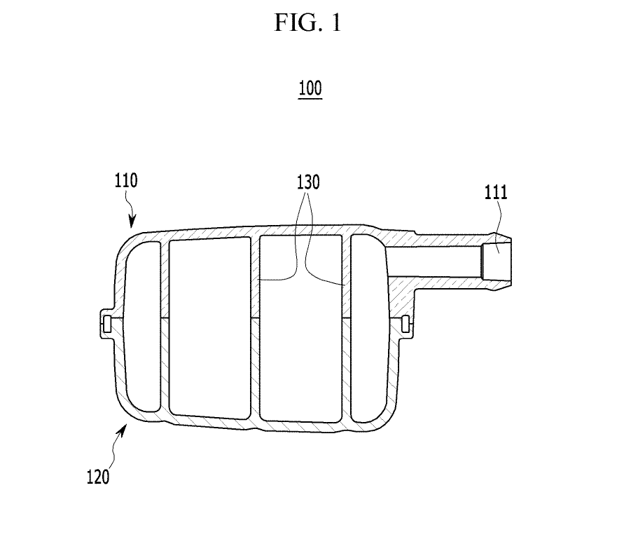

FIG. 2 is a perspective view of the reservoir tank according to the exemplary embodiment of the present invention.

FIG. 3 is an exploded perspective view of the reservoir tank according to the exemplary embodiment of the present invention.

FIG. 4 is a cross-sectional view taken along line A-A of FIG. 2.

FIG. 5 is a perspective view of an upper body of the reservoir tank according to the exemplary embodiment of the present invention.

FIG. 6 is a perspective view of a lower body of the reservoir tank according to the exemplary embodiment of the present invention.

FIG. 7 includes diagrams (A) and (B) illustrating a comparative experiment of a water passage resistance and a flow of coolant of the reservoir tank according to the exemplary embodiment of the present invention and the reservoir tank according to the related art, respectively.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, an exemplary embodiment of the present invention will be described with reference to the accompanying drawings. However, the following illustrated drawing and the detailed description to be described below relate to one exemplary embodiment among several exemplary embodiments for effectively describing features of the present invention. Therefore, the present invention is not limited to only the following drawings and the description.

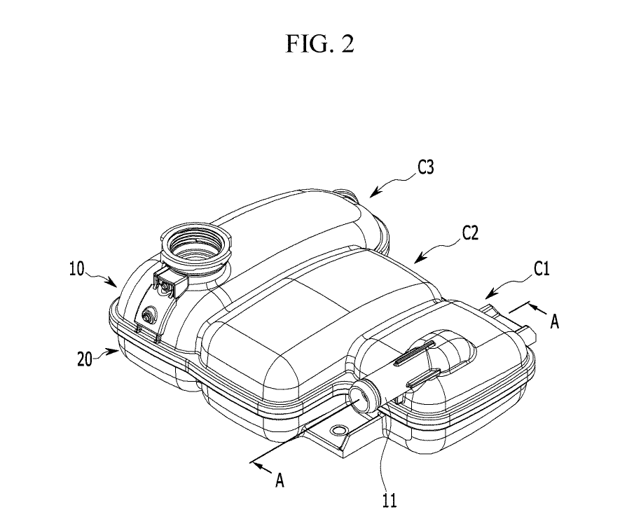

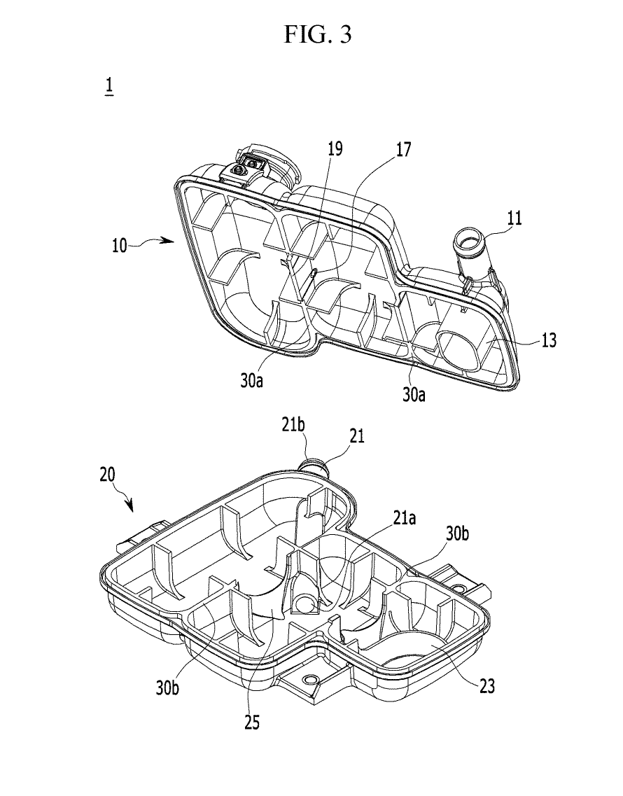

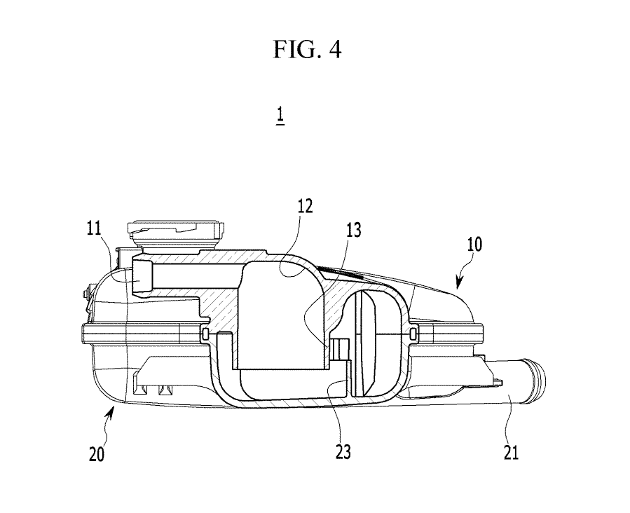

FIG. 2 is a perspective view of the reservoir tank according to the exemplary embodiment of the present invention, FIG. 3 is an exploded perspective view of the reservoir tank according to the exemplary embodiment of the present invention, and FIG. 4 is a cross-sectional view taken along line A-A of FIG. 2.

Referring to FIGS. 2 to 4, a reservoir tank 1 according to an exemplary embodiment of the present invention includes an upper body 10 and a lower body 20. In a state in which the upper body 10 and the lower body 20 are assembled to each other, an inside of the reservoir tank 1 is partitioned into a plurality of chambers by partition walls so that the reservoir tank 1 is installed on a coolant passage.

In this case, an example in which the plurality of chambers are partitioned into a first chamber C1, a second chamber C2, and a third chamber C3 will be described.

The exemplary embodiment of the present invention describes the example in which the plurality of chambers are partitioned into the first chamber C1, the second chamber C2, and the third chamber C3, but is not necessarily limited thereto. Therefore, the number of chambers partitioned may be greater or lesser than three chambers.

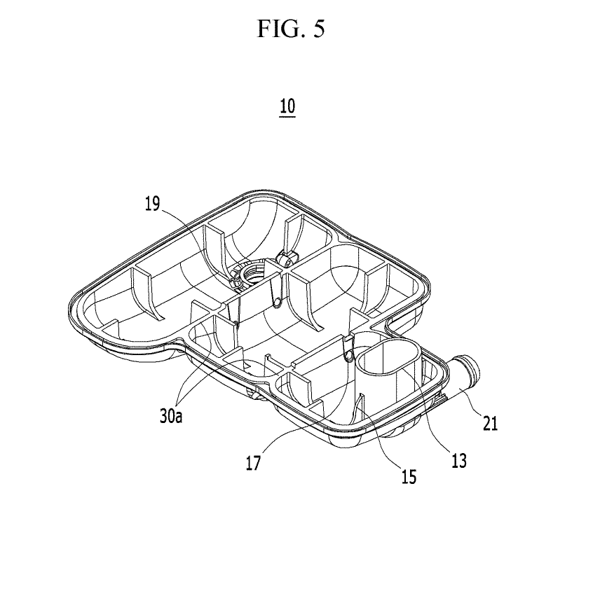

FIG. 5 is a perspective view of an upper body of the reservoir tank according to the exemplary embodiment of the present invention.

Referring to FIGS. 3 to 5, the upper body 10 is provided with a plurality of upper partition walls 30a along a width direction. In this case, the number of upper partition walls 30a may be two.

Further, the upper body 10 forms an upper space of the first to third chambers C1, C2, and C3 that are partitioned by the two upper partition walls 30a.

Further, one side of an upper portion of the upper body 10 is provided with an inflow pipe 11 in parallel with the upper body 10.

In particular, one side of the upper portion of the upper body 10 corresponding to the first chamber C1 may be provided with the inflow pipe 11 in parallel with the upper body 10.

The upper body 10 is integrally connected to the guide pipe 13 in a vertical direction to the inflow pipe 11.

In this case, a coolant flow cross sectional area of the guide pipe 13 is formed to be larger than that of the inflow pipe 11, and preferably, the coolant flow cross sectional area of the guide pipe 13 is set to be two times or larger than that of the inflow pipe and the guide pipe 13 is formed to guide coolant downwardly of the first chamber C1.

Further, rigidity of the guide pipe 13 is reinforced by connecting at least two reinforcing ribs 15 to a side surface and an inner surface of the upper body 10.

An inner surface 12 of a bent outer side of a connection part between the inflow pipe 11 and the guide pipe 13 having the foregoing configuration is formed in a rounded curved surface. As a result, it is possible to minimize a reduction in a flow velocity of coolant and prevent a sudden change in a coolant passage when the coolant inflows.

Further, the respective upper partition walls 30a of the upper body 10 is provided with a plurality of air bleeding holes 17 that are formed to be close to an inner side of the upper portion of the upper body 10.

Further, the respective upper partition walls 30a of the upper body 10 are provided with flow grooves 19. The flow groove 19 corresponds to a flow guider 25 of the lower body 20 to be described below to make the coolant flow between the respective chambers C1, C2, and C3, along with the flow guider 25.

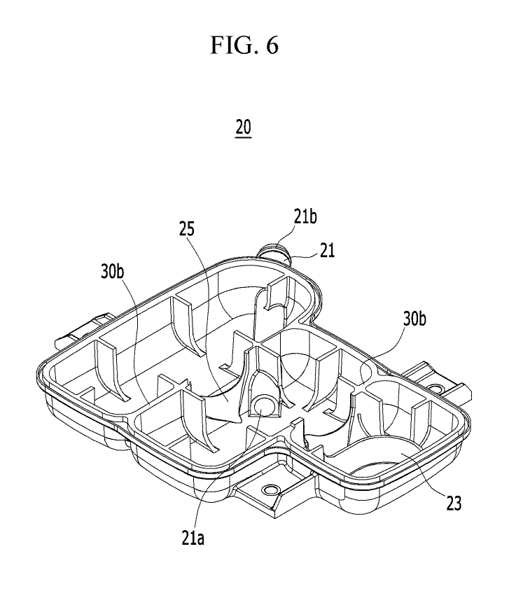

FIG. 6 is a perspective view of a lower body of the reservoir tank according to the exemplary embodiment of the present invention.

Referring to FIGS. 3, 4, and 6, the lower body 20 is assembled to the lower portion of the upper body 10 and like the upper body 10, is provided with a plurality of lower partition walls 30b along a width direction. In this case, the number of lower partition walls 30b may be two.

Further, the lower body 20 forms a lower space of the first to third chambers C1, C2, and C3 that are partitioned by the two lower partition walls 30b.

Further, the lower body 20 is provided with a discharge pipe 21 to guide a discharge of coolant.

In this case, an inlet 21a of the discharge pipe 21 is positioned at a central portion of the lower body 20.

In particular, the inlet 21a of the discharge pipe 21 is positioned on the lower body 20 corresponding to the second chamber C2.

Further, the inlet 21a of the discharge pipe 21 is positioned at an outside of the lower body 20 by penetrating through the central portion of the lower body 20.

That is, the inlet 21a of the discharge pipe 21 is positioned at the outside of the lower body 20 by penetrating through the third chamber C3 from the second chamber C2.

The lower body 20 is provided with a guide rib 23 corresponding to the guide pipe 13 of the upper body 10 to enclose an outer side of a tip portion of the guide pipe 13.

In particular, the guide rib 23 is spaced from the outer side of the tip portion of the guide pipe 13 at a predetermined interval to form a coolant passage between the guide rib 23 and the guide pipe 13.

The guide rib 23 is formed by connecting between one side surface and another side surface (i.e., the other side surface) of a corner of one side of the lower body 20 corresponding to the guide pipe 13.

That is, the guide rib 23 is formed by connecting between one side surface and the other side surface of a corner of one side of the lower body 20 corresponding to the first chamber C1.

The guide rib 23 is connected to one side surface and the other side surface of the corner of one side of the first chamber C1 to form one closed section.

In this case, the guide rib 23 serves to upwardly guide the flow of coolant inflowing from the guide pipe 13.

Further, central portions of the respective lower partition walls 30b of the lower body 20 are provided with the flow guider 25 that guides the flow of coolant among the respective chambers C1, C2, and C3.

The flow guider 25 has a curved rectangular plate shape bent in a diagonal direction.

The flow guider 25 is formed on the respective lower partition walls 30b of the lower body 20 so that both corners bent in a diagonal direction each direct to both chambers.

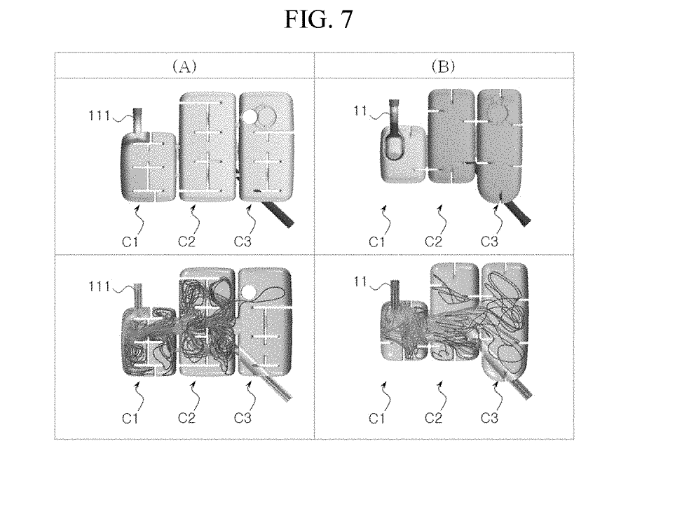

FIG. 7 includes diagrams (A) and (B) illustrating a comparative experiment of a water passage resistance and a flow of coolant of the reservoir tank according to the exemplary embodiment of the present invention and the reservoir tank according to the related art, respectively.

FIG. 7 (A) is a diagram illustrating the water passage resistance and the flow of coolant of the reservoir tank according to the related art, and it can be appreciated from FIG. 7 (A) that if the water passage resistance of the inflow pipe 11 is increased, the inflowing coolant inflows in the first chamber C1 and stays in the second chamber C2, and therefore the flow of coolant is not smoothed.

FIG. 7 (B) is a diagram illustrating the water passage resistance and the flow of coolant of the reservoir tank according to the exemplary embodiment of the present invention and it can be appreciated from FIG. 7 (B) that if the water passage resistance of the inflow pipe 11 is greatly reduced, the inflowing coolant smoothly inflows up to the third chamber C3 through the first chamber C1 and the second chamber C2.

Therefore, in the reservoir tank 1 according to the exemplary embodiment of the present invention, the guide pipe 13 connected to the inflow pipe 11 is applied to prevent the coolant inflowing through the inflow pipe 11 from being scattered, thereby minimizing the bubble generation of the coolant.

Further, in the reservoir tank 1 according to the exemplary embodiment of the present invention, the inner surface 12 of the bent outer side of the connection part between the inflow pipe 11 and the guide pipe 13 has the rounded shape to prevent the flow velocity from reducing due to the collision upon the inflow of coolant and minimize the flow resistance due to the sudden change in the passage, thereby suppressing the generation of bubbles.

Further, in the reservoir tank 1 according to the exemplary embodiment of the present invention, the coolant flow cross sectional area of the guide pipe 13 is formed to be larger than that of the inflow pipe 11 to minimize the water passage resistance and increase the actual vehicle flux, thereby improving the cooling performance.

Further, the guide rib 23 is simply formed using the side surface of the lower body 20 and is spaced apart from the outer side of the tip portion of the guide pipe 13 at a predetermined interval to form the coolant passage between the guide rib 23 and the guide pipe 13, such that the flow of coolant inflowing from the guide pipe 13 may be naturally guided upwardly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A reservoir tank in which an upper body provided with an inflow pipe and a lower body provided with a discharge pipe are assembled to each other, and an inside of the upper body and the lower body is installed on a coolant passage while being partitioned into a plurality of chambers, comprising:
one side of an upper portion of the upper body is provided with the inflow pipe parallel therewith and the upper body is integrally connected to a guide pipe in a vertical direction to the inflow pipe to downwardly guide coolant, and
the lower body is provided with a guide rib corresponding to the guide pipe to enclose an outer side of a tip portion of the guide pipe while the guide rib is spaced apart from the outer side of the tip portion of the guide pipe at a predetermined interval to form the coolant passage between the guide rib and the guide pipe.

2. The reservoir tank of claim 1, wherein:
a coolant flow cross sectional area of the guide pipe is formed to be larger than that of the inflow pipe.

3. The reservoir tank of claim 2, wherein:
the coolant flow cross sectional area of the guide pipe is set to be two times or larger than that of the inflow pipe.

4. The reservoir tank of claim 1, wherein:
an inner surface of a bent outer side of a connection part between the inflow pipe and the guide pipe is formed in a rounded curved surface.

5. The reservoir tank of claim 1, wherein:
the guide pipe is connected to a side surface and an inner surface of the upper body by at least two reinforcing ribs.

6. The reservoir tank of claim 1, wherein:
the guide rib is formed by connecting between one side surface and another side surface of a corner of one side of the lower body corresponding to the guide pipe.

7. The reservoir tank of claim 1, wherein:
an inlet of the discharge pipe is positioned at a central portion of the lower body.

8. The reservoir tank of claim 7, wherein:
an outlet of the discharge pipe is positioned at an outer side of the lower body by penetrating through the central portion of the lower body.

9. The reservoir tank of claim 1, wherein:
the upper body has partition walls for partitioning a plurality of chambers and the respective partition walls of the upper body are provided with a plurality of air bleeding holes.

10. The reservoir tank of claim 1, wherein:
the lower body has partition walls for partitioning a plurality of chambers and central portions of the respective partition walls of the lower body are provided with flow guiders guiding a flow of coolant between the respective chambers.

11. The reservoir tank of claim 10, wherein:
the flow guider has a curved rectangular plate shape bent in a diagonal direction and both corners bent in the diagonal direction are each formed on the respective partition walls of the lower body to direct to both chambers.

12. The reservoir tank of claim 10, wherein:
the respective partition walls of the upper body are provided with flow grooves corresponding to the flow guiders to make coolant flow between the respective chambers, along with the flow guiders.

13. A reservoir tank for a vehicle, comprising:
an upper body provided with an inflow pipe;
a lower body provided with a discharge pipe, the upper and lower bodies being assembled to each other;
an inside of the upper body and the lower body installed on a coolant passage while being partitioned into a plurality of chambers;
one side of an upper portion of the upper body provided with the inflow pipe parallel therewith, wherein the upper body is integrally connected to a guide pipe in a vertical direction to the inflow pipe to downwardly guide coolant; and
the lower body is provided with a guide rib corresponding to the guide pipe to enclose an outer side of a tip portion of the guide pipe while the guide rib is spaced apart from the outer side of the tip portion of the guide pipe at a predetermined interval to form the coolant passage between the guide rib and the guide pipe.
